(19) United States
(12) Patent Application Publication
(10) Pub. No.: US 2010/0038483 A1
(43) Pub. Date: Feb. 18, 2010

(54) SEAT TRACK FITTINGS

(76) Inventor: Scott Yamasaki, Orange, CA (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/370,715

(22) Filed: Feb. 13, 2009

Related U.S. Application Data
(60) Provisional application No. 61/028,645, filed on Feb. 14, 2008.

(51) Int. Cl. B64D 11/06; B23P 11/00

(52) U.S. Cl. 244/118.6; 248/503.1; 29/428

(57) ABSTRACT

Fittings configured primarily, although not necessarily exclusively, for connection to aircraft seat tracks are detailed. The fittings may engage multiple openings of a seat track concurrently. No rotation of a fitting need occur when connecting it to a track. Instead, if desired the fitting need move only linearly.

### CROSS REFERENCE TO RELATED APPLICATION

This application claims the benefit of U.S. Provisional Application No. 61/028,645 filed on Feb. 14, 2008, the contents of which are incorporated herein by reference.

### FIELD OF THE INVENTION

This invention relates to components of vehicles such as aircraft and more particularly, although not necessarily exclusively, to fittings connecting seats or other furniture with floor-mounted tracks.

### BACKGROUND OF THE INVENTION

Seat tracks of various sorts exist in many commercial passenger aircraft. Such tracks typically are mounted to (or in) floors of the cabins of the aircraft and contain multiple spaced holes in their upper surfaces. Passenger seats and additional cabin, cockpit, or cargo components may be attached to the tracks using fasteners or other fittings.

U.S. Patent Publication No. 2008/0001050 of Morel, et al., illustrates an exemplary seat track intended, principally, for use on-board a commercial aircraft. Included as part of the seat track are a base plate and a crown. Spaced openings within the crown are configured to receive fittings via which objects may be connected to the track, with the fittings usually being removable to permit reconfiguration of the objects as desired.

U.S. Patent Publication No. 2007/0215769 of Nebeker, et al., details both another exemplary seat track and a fitting adapted for connection thereto. Designated a “retaining component” (or a “retaining member”) in the Nebeker publication, the fitting contains a base portion from which flanges extend. Located on the base portion as well are a flexible portion including a locking tab and multiple “hook-shaped engaging tabs” alignable with holes in the seat track. As described in the Nebeker publication:
[W]hen the retaining member is to be secured to a seat track, the retaining member is aligned such that the hook-shaped engaging tabs are positioned over holes in a flange of the seat track. The retaining member is then lowered onto the flange such that the engaging tabs pass through the holes. A small amount of pressure . . . is required at this point to force the retaining member down against the flange such that the engaging tabs are fully extended through the holes. As pressure is applied . . . , the locking tab, which is slightly laterally displaced from its associated hole . . . , forces the flexible portion to flex upward slightly into [a] channel of the [retaining member] as the retaining member is held against the flange.

### See Nebeker, p. 2, col. 2, ¶0023.

Disclosed in U.S. Pat. No. 5,058,829 to Bentley is a fitting designed to attach a leg member of a seat to a seat track. The fitting connects the seat to the track in a satisfactory manner while allowing some movement of the leg member. In particular, a “bolting member and bolt-receiving channel interact to allow the bolting member to rock, pivot and/or rotate in the channel.” See Bentley, col. 1, 1. 67 through col. 2, 1. 1. The contents of the Morel and Nebeker publications and of the Bentley patent are incorporated herein in their entireties by this reference.

### SUMMARY OF THE INVENTION

The present invention details alternate fittings to those illustrated in the Nebeker publication and Bentley patent. The fittings are intended principally for use with seat tracks of the Boeing 787 aircraft, for which only the upper surfaces of the tracks will be accessible. They nevertheless may be used as appropriate with other seat tracks or similar apparatus on-board vehicles or elsewhere.

In some versions of the invention, a fitting includes a first (nominally vertical) member with a (nominally downwardly) protruding hook-shaped end. These embodiments also comprise a flange adjacent the first member and also protruding nominally downwardly from a main body. In use, the first member, together with the adjacent flange, may be used to lock the fitting to a seat track. An optional, nominally downwardly protruding second member also may be provided when desired to ensure correct orientation of the fitting relative to the track.

To connect these fittings to a seat track, the first member may be aligned with a first opening of the track and then inserted into the first opening so that (1) the hook-shaped end is below the upper surface of the track and (2) the flange abuts (or is adjacent) the upper surface of the track. The fitting may then be translated linearly so that the flange is completely aligned with the first opening, after which the flange too may be inserted into the first opening. Thereafter, the first member may be translated nominally upward, so that the hook-shaped end contacts the underside of the upper surface of the seat track. Locking the first member in place at this time effectively clamps the fitting about the upper surface of the seat track, attaching the two together. Anything connected to the fitting, therefore, may be connected to the seat track via the attached fitting.

It thus is an optional, non-exclusive object of the present invention to provide components for connecting objects to tracks.

It is another optional, non-exclusive object of the present invention to provide fittings designed for use with seat tracks in aircraft or other vehicles.

It is a further optional, non-exclusive object of the present invention to provide fittings with two members projecting from a main body, at least one of the members having a hook-shaped end.

It is also an optional, non-exclusive object of the present invention to provide fittings engaging multiple openings of a seat track concurrently.

It is, moreover, an optional, non-exclusive object of the present invention to provide fittings adapted to be translated linearly (and not rotated) in position in order to engage a seat track.

Other objects, features, and advantages of the present invention will be apparent to those skilled in the appropriate field with reference to the remaining text and the drawings of this application.

### BRIEF DESCRIPTION OF THE DRAWINGS

FIG. 1 is an isometric view of an exemplary fitting of the present invention together with a seat track designed for use, at least initially, in a Boeing 787 aircraft.

FIGS. 2-7 are cross-sectional views of the fitting and part of the track depicted in FIG. 1, with many of the views illustrating events occurring to attach the fitting to the track.

### DETAILED DESCRIPTION

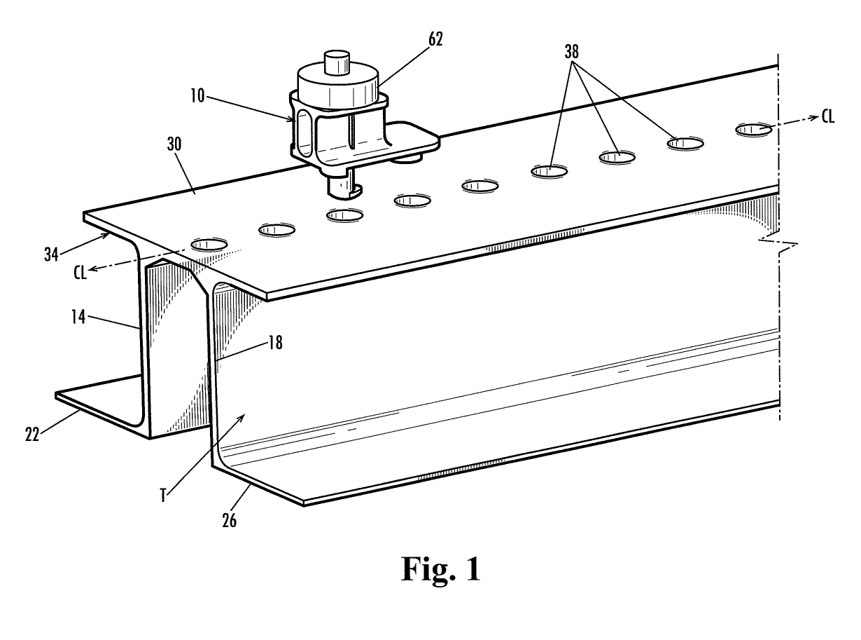

Shown in FIGS. 1-6 is fitting 10 of the present invention. Also disclosed in the figures is seat track T designed, at least initially, for use on-board the Boeing 787 aircraft. Track T is constructed somewhat as an I-beam, with vertical, spaced sides 14 and 18 from which lower flanges 22 and 26 protrude, respectively. Integrally formed with or otherwise connected to sides 14 and 18 is upper surface 30 having underside 34. Formed (preferably) along the longitudinal centerline CL of upper surface 30 are multiple spaced openings 38. In use, openings 38 receive portions of fitting 10 so that fitting 10 may be both firmly attached to track T but also removable therefrom. Fitting 10, in turn, may be firmly connected to a passenger or crew seat (or other object) and, if appropriate or desired, likewise removable therefrom.

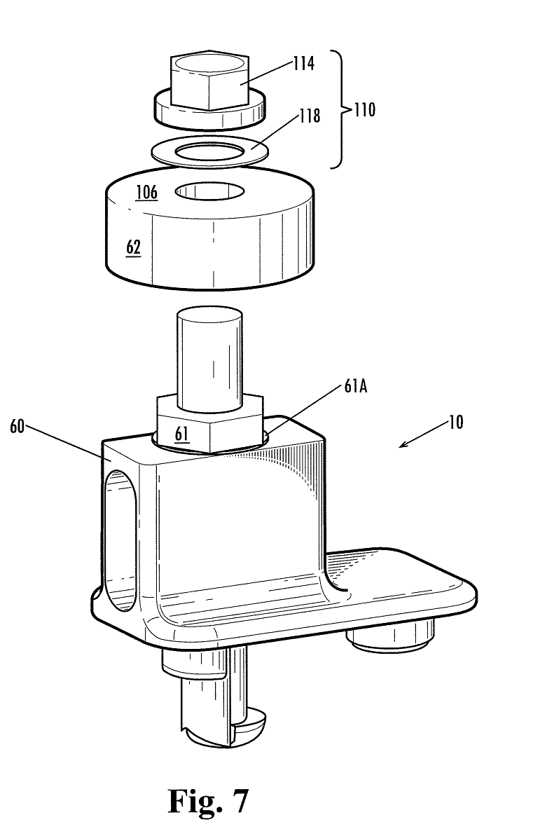

Fitting 10 may comprise at least body 42, first member 46, and (optional) second member 50. First member 46 extends (nominally) vertically through body 42 and defines respective upper and lower ends 54 and 58. In use, upper end 54 advantageously extends above upper portion 60 of body 42 to facilitate engagement with locking nut 61 (and, if desired, washer 61A) as shown in FIG. 7. Lower end 58, by contrast, extends below lower portion 66 of body 42. Lower end 58, further, advantageously has a hook shape and is of a size so that it may pass through an opening 38. Body 42 also may comprise flange 90 adjacent first member 46. Size of the combination of flange 90 and central section 74 of first member 46 is similar to the size of an opening 38.

Although first member 46 is adapted for movement relative to body 42, second member 50 preferably is not. Instead, second member 50 beneficially is integrally formed with or connected to lower portion 66 so as to extend downward from body 42. Like first member 46, second member 50 is sized to that it may enter and be received by an opening 38. Preferably, however, second member 50 has circular cross-section of diameter approximately the same as that of an opening 38, so that second member 50 essentially fills the diameter of an opening 38 when inserted therein. As noted above, second member 50 need not necessarily be present, however.

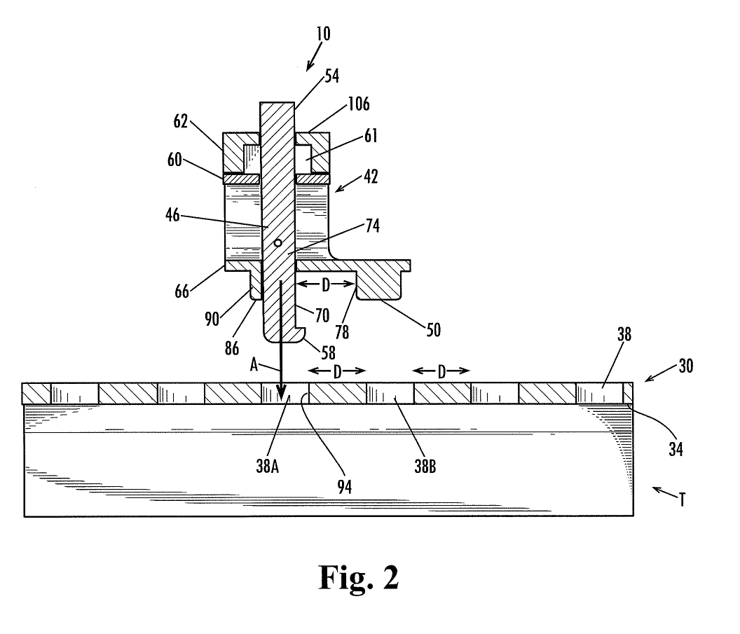

Leading edge 70 of central section 74 of first member 46 is spaced from trailing edge 78 of second member 50 a distance D. Distance D likewise defines the approximate spacing between two adjacent openings 38 (designated 38A and 38B) in FIGS. 2-6. Fitting 10 thus is configured so that it may engage two openings 38 concurrently. Although openings 38A and 38B are depicted as adjacent, those skilled in the art will understand that fitting 10 may be redesigned to engage two (or more) non-adjacent openings 38 instead.

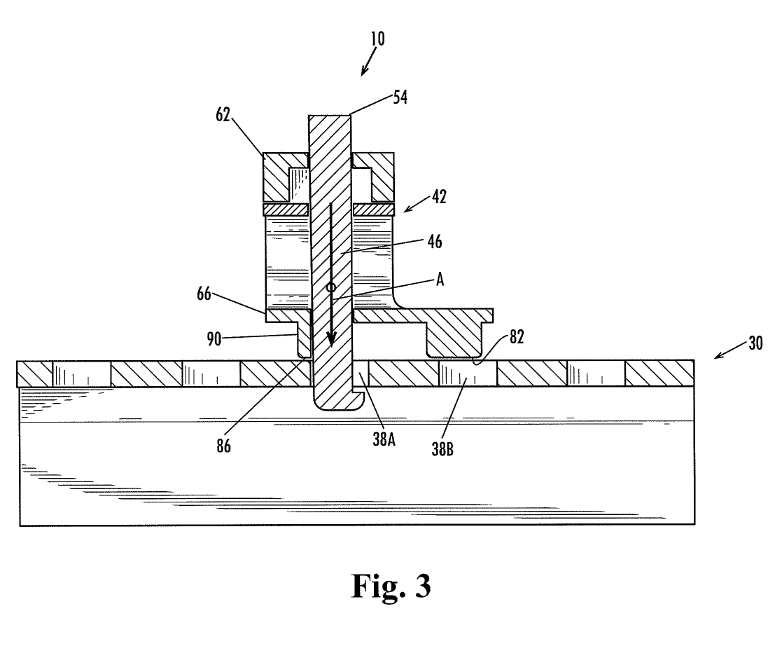

FIGS. 2-6 illustrate movement of fitting 10 as it is attached to seat track T. Initially, first member 46 may be aligned with opening 38A (see FIG. 2). Fitting 10 may then be lowered (i.e. moved linearly in the direction indicated by arrow A) so that lower end 58 of first member 46 passes through opening 38A. Such lowering may occur until lower edges 82 and 86 of, respectively, second member 50 (if present) and flange 90 contact upper surface 30 (see FIG. 3).

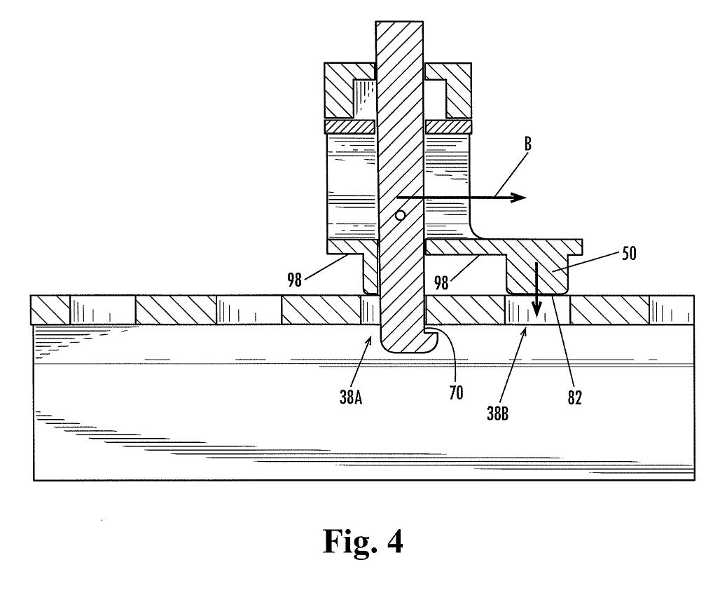

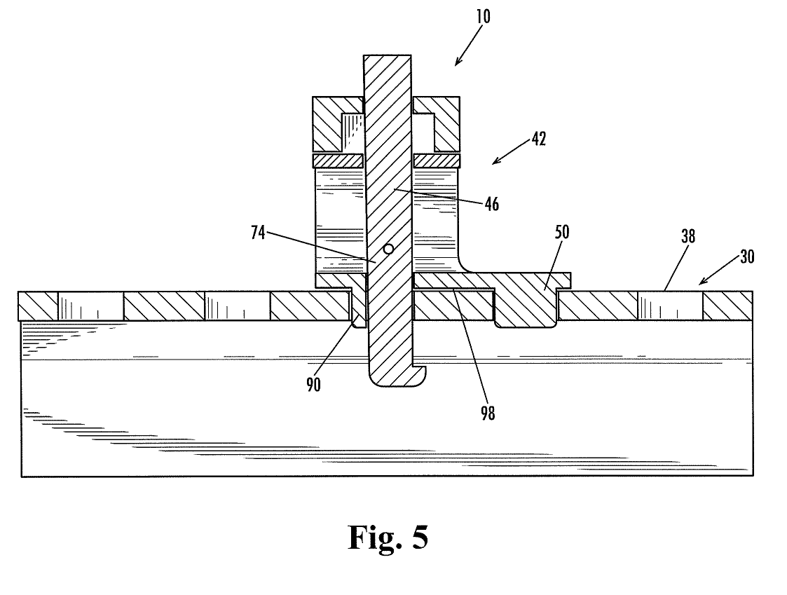

As shown in FIG. 4, fitting 10 may then be moved (translated) linearly in the direction indicated by arrow B until leading edge 70 contacts (or is adjacent) boundary 94 (denoted in FIG. 2) defining opening 38A. At this point flange 90 is aligned with opening 38A and its lower edge 86, as well as lower edge 82, no longer contact upper surface 30. Fitting 10 thus may be lowered (i.e. moved in the direction of arrow A) further so that opening 38A receives flange 90 and opening 38B receives second member 50 (see FIG. 5). Because flange 90 preferably is semi-circular, its width is such that, when added to the diameter of central section 74 of first member 46, the total is essentially equal to the diameter of opening 38A. Thus further lowering of fitting 10 may occur until lower edge 98 of body 42 contacts upper surface 30.

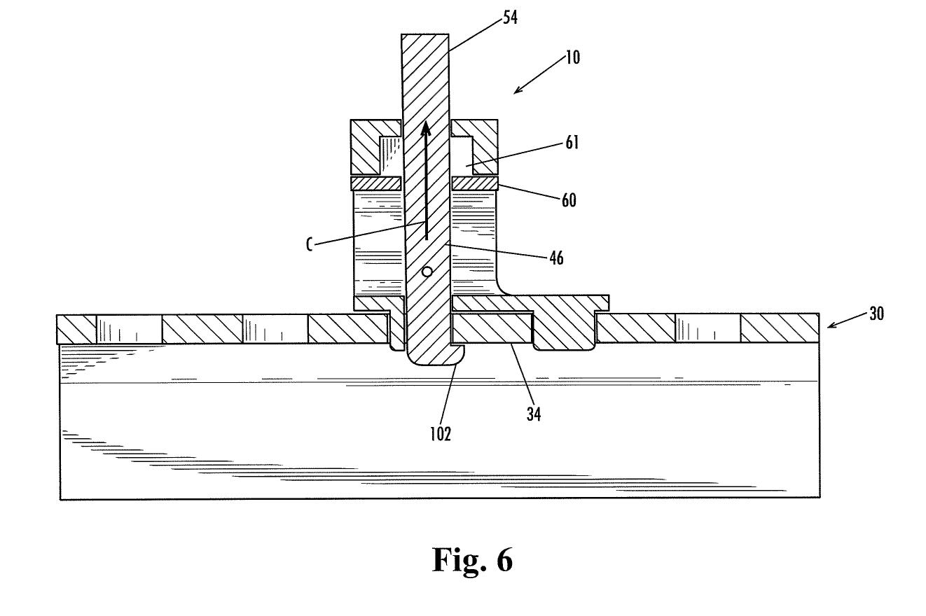

Final assembly of fitting 10 and track T is depicted in FIG. 6. After first member 46 and second member 50 (if present) are received by openings 38A and 38B, first member 46 may be moved upward (in the direction of arrow C) until hook 102 contacts underside 34 of upper surface 30. Such movement of first member 46 relative to body 42 may be instituted in any appropriate way. Preferably, though, locking nut 61 and washer 61A are placed about upper end 54 and mounted atop upper portion 60 of body 42. First member 42 may, for example, be threaded such that rotation of nut 61 (as through use of a box wrench) causes the upward movement. Those skilled in the art will, of course, recognize that pin and slot mechanisms or other devices may be used instead.

As a consequence of the final assembly shown in FIG. 6, upper surface 30 is clamped between hook 102 and lower edge 98, thus precluding relative vertical movement between fitting 10 and seat track T. The combination of first member 46 and flange 90 fills opening 38A, and second member 50 (if present) fills opening 38B, further, precluding relative horizontal movement between fitting 10 and track T. Hence, any object fixedly connected to fitting 10 may, via the fitting 10, be fixed to track T.

In at least some versions of the invention, an ottoman will connect to upper end 54 of first member 46 of fitting 10 for fixing to track T. FIGS. 1-7 illustrate spacer 62, which may be placed (i) over nut 61, (ii) about upper end 54, and (iii) atop upper portion 60 of body 42. Spacer 62 itself provides a mounting surface 106 located above nut 61. In use, a leg, monument, or other portion of the ottoman (or other to-be-attached object) may be positioned on mounting surface 106 and clamped between the surface 106 and second nut assembly 110 (comprising, e.g., nut 114 and washer 118 as shown in FIG. 7).

The foregoing is provided for purposes of illustrating, explaining, and describing embodiments of the present invention. Modifications and adaptations to these embodiments will be apparent to those skilled in the art and may be made without departing from the scope or spirit of the invention. Directional terms (such as “upper,” “lower,” “upward,” “downward,” “vertical,” “horizontal,” etc.) referenced herein are used in a relative, rather than absolute, sense. Thus, as an example, if track T is reoriented opposite the manner depicted in FIG. 1, “lower” flanges 22 and 26 may be above “upper” surface 30.

Additionally, optional second member 50, for example, when present need not necessarily be configured as shown in FIGS. 1-7. Instead, it could comprise another hooked rod or member designed further to clamp upper surface 30 between the hook and lower edge 98. Reconfiguring second member 50 in this manner might increase total loading sustainable by fitting 10 if necessary or desirable to do so.

What is claimed is:

1. A fitting configured for use with a track having at least one opening, comprising:
a. a body comprising an upper portion, a lower portion, and a flange extending below the lower portion; and
b. a first member extending through the body and comprising an upper end extending above the upper portion of the body and a lower end extending below the lower portion of the body, the lower end having a hook shape and sized so as to pass through the opening.

2. A fitting according to claim 1 in which the flange is adjacent the first member and may pass through the opening.

3. A fitting according to claim 2 further comprising a locking nut engaging the upper end of the first member.

4. A fitting according to claim 2 further comprising a second member extending below the lower portion of the body.

5. A fitting according to claim 4 in which the first member is moveable relative to the body but the second member is not moveable relative to the body.

6. A fitting according to claim 5 in which the track has a second opening and the second member is sized to pass through the second opening when the flange passes through the opening.

7. A fitting according to claim 6 configured for placement within an aircraft.

8. An aircraft comprising:
a. a track having at least one opening;
b. a fitting connected to the track and comprising:
i. a body comprising an upper portion, a lower portion, and a flange extending below the lower portion; and
ii. a first member extending through the body and comprising an upper end extending above the upper portion of the body and a lower end extending below the lower portion of the body, the lower end having a hook shape and sized so as to pass through the opening; and
c. a seat connected to the fitting.

9. A method of attaching a fitting to a track having an upper surface, an underside, and at least one opening, comprising:
a. passing a hook-shaped end of a member of the fitting through the opening until a flange of the fitting contacts the upper surface;
b. moving the fitting so the flange no longer contacts the upper surface;
c. passing the flange through the opening until the lower edge of a body of the fitting contacts the upper surface; and
d. moving the fitting so that the hook-shaped end of the member contacts the underside of the track.

10. A method of attaching a fitting to a track having an upper surface, an underside, and spaced first and second openings, comprising:
a. passing a hook-shaped end of a first member of the fitting through the first opening until a flange and a second member of the fitting contact the upper surface;
b. moving the fitting so the flange and second member no longer contact the upper surface;
c. passing the flange through the first opening and the second member through the second opening until the lower edge of a body of the fitting contacts the upper surface; and
d. moving the fitting so that the hook-shaped end of the first member contacts the underside of the track.
